(19) United States
(12) Patent Application Publication
(10) Pub. No.: US 2005/0205666 A1
(43) Pub. Date: Sep. 22, 2005

(54) Loyalty automatic merchandiser system

(76) Inventors: Kevin B. Ward, St. Charles, MO (US); Ronald A. Hoormann, St. Charles, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/080,263

(22) Filed: Mar. 15, 2005

Related U.S. Application Data
(60) Provisional application No. 60/553,776, filed on Mar. 16, 2004.

(51) Int. Cl. G06F 7/08

(52) U.S. Cl. 235/381

(57) ABSTRACT

A loyalty automatic merchandiser system comprises a vending machine capable of vending product, the vending machine having an input device for receiving identification information of a customer purchasing product from the vending machine, and a transaction controller for storing and transmitting information concerning identification information and product purchased, and a loyalty tracking system for registering a customer and assigning identification information for a customer, for receiving identification information and product purchased from the transaction controller, and for awarding points based on product purchased.

### CROSS-REFERENCE TO RELATED APPLICATIONS

This application claims priority to U.S. Provisional patent application Ser. No. 60/553,776, entitled LOYALTY AUTOMATIC MERCHANDISER SYSTEM that was filed on Mar. 16, 2004.

### BACKGROUND OF THE INVENTION

This invention relates to a loyalty automatic merchandiser system and method, and more particularly, to a loyalty program for tracking, accumulating, and converting points for purchases from an automatic merchandiser or a vending machine or a network of automatic merchandisers or vending machines.

Automatic merchandisers or vending machines include various electronic control devices for vending merchandise or products. Vending machines are typically equipped with coin changers and bill validators for authenticating coins or paper bills inserted into the vending machine. Some vending machines are equipped with smart card readers or credit card readers that accept a smart card or a credit card as a payment device. Once coins or bills are authenticated or a smart card or a credit card are accepted, the vending machine will allow purchase of an item stored within the machine and the item will be dispensed or vended to a customer. However, once a purchase is made, the customer only receives the product with no other added benefit. In particular, there are known loyalty or frequency programs that award “points” or “miles” based upon the purchase of specific products or services. By way of example, one popular loyalty program is a frequent flyer program administered by most airlines. In such programs, members of the program are awarded points or miles based upon a number of factors that include the cost of a ticket, the number of miles flown, or the number of flights made during a specific time period. Further, some programs offer the availability of accumulating more points based upon purchase of goods or services from other companies that have partnered with the airline. Once a member of the program accumulates sufficient points or miles, the member may exchange the points for an airline ticket or other awards offered by the airline or the partner of the airline.

One disadvantage associated with the known frequent flyer programs is that the only benefit is the award of a free airline ticket only for the sponsoring airline. Another disadvantage of the frequent flyer program is that there are a limited number of seats per plane that are available for free travel. There is no guarantee that a seat will be available at a time when a member wants to travel for free. Additionally, such programs require the accumulation of a large number of points or miles before a member may redeem the points for an airline ticket. Further, a member may be locked into one airline that may be inconvenient.

Accordingly, it is desirable and advantageous to provide a system and method for registering, tracking, calculating, and redeeming points awarded under a loyalty program associated with purchases from a vending machine. The present invention is designed to allow users access to a system to register in a loyalty program by use of a computerized communications network, such as the Internet. For example, registered users may have a password that allows access to a particular web page to easily access information concerning their individual loyalty program points accrued based upon usage at vending machines, to track the accumulation of these points, and to convert these points to purchases. In particular, the present invention accomplishes a loyalty program by using one or more vending machines to track purchases made by a registered user. The purchases are associated with a registered user and the purchase information is submitted to a central location that tracks purchases. In this manner, a registered user will benefit from purchasing from a vending machine.

### SUMMARY OF THE INVENTION

In one form of the present invention, a loyalty automatic merchandiser system comprises a vending machine capable of vending product, the vending machine having an input device for receiving identification information of a customer purchasing product from the vending machine, and a transaction controller for storing and transmitting information concerning identification information and product purchased, and a loyalty tracking system for registering a customer and assigning identification information for a customer, for receiving identification information and product purchased from the transaction controller, and for awarding points based on product purchased.

In another form of the present invention, a loyalty automatic merchandiser system comprises a vending machine capable of vending product, the vending machine having an input device for receiving identification information of a customer purchasing product from the vending machine, a transaction controller for storing and transmitting information concerning identification information and product purchased, and a loyalty tracking system for registering a customer and assigning identification information for a customer, for receiving identification information and product purchased from the transaction controller, and for awarding points based on product purchased.

In still another form of the present invention, a loyalty automatic merchandiser system comprises a vending machine capable of vending product, the vending machine having a transaction controller, the transaction controller having an input device for receiving identification information of a customer purchasing product from the vending machine with the transaction controller for storing and transmitting information concerning identification information and product purchased, and a loyalty tracking system for registering a customer and assigning identification information for a customer, for receiving identification information and product purchased from the transaction controller, and for awarding points based on product purchased.

Accordingly, it will be recognized that an object of the present invention is to provide a loyalty automatic merchandiser system for a vending machine that is capable of tracking, accumulating, and converting points.

A further object of the present invention is to provide a loyalty automatic merchandiser system that may be employed with remotely located vending machines.

Another object of the present invention is to provide a loyalty automatic merchandiser system that can award loyalty points to be used to purchase products.

A still further object of the present invention is to provide a loyalty automatic merchandiser system that can award free products for vending machines that employ a lottery system.

A further object of the present invention is to provide a loyalty automatic merchandiser system that uses one or more vending machines to track purchases made by a registered user.

These and other objects and advantages of the present invention will become apparent after considering the following detailed specification in conjunction with the accompanying drawings, wherein:

### BRIEF DESCRIPTION OF THE DRAWINGS

FIG. 1 is a generalized block diagram of a preferred embodiment of a loyalty automatic merchandiser system constructed according to the present invention;

FIG. 2 is a generalized block diagram of a vending machine and input device employed in the loyalty automatic merchandiser system of the present invention;

FIG. 3 is a generalized block diagram of another preferred embodiment of a loyalty automatic merchandiser system constructed according to the present invention;

FIG. 4 is a generalized block diagram of another preferred embodiment of a loyalty automatic merchandiser system constructed according to the present invention;

FIG. 5 is a generalized block diagram of another preferred embodiment of a loyalty automatic merchandiser system constructed according to the present invention; and

FIG. 6 is a generalized block diagram of another preferred embodiment of a loyalty automatic merchandiser system constructed according to the present invention.

### DETAILED DESCRIPTION OF THE PREFERRED EMBODIMENTS

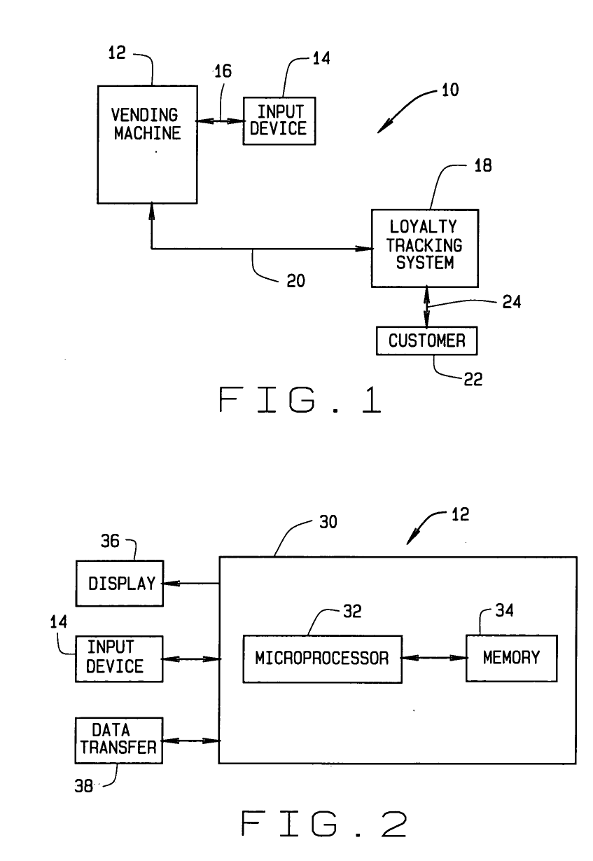

Referring now to the drawings, wherein like numbers refer to like items, number 10 identifies a preferred embodiment of a loyalty automatic merchandiser system constructed according to the present invention. With reference now to FIG. 1, the system 10 is shown comprising an automatic merchandiser or vending machine 12 having an input device 14 with the input device 14 being electrically connected to the vending machine 12 via a connection 16. The vending machine 12 is connected to a loyalty tracking system 18 via a communication connection 20. The communication connection 20 may include, by way of example only, a telephone line, a cable line, a network connection such as Ethernet, Intranet, or Internet, a satellite connection, an infrared connection, a wireless connection, or any other electrical type connection. A customer 22 by a connection 24 may interface with the loyalty tracking system 18. The connection 24 may take on the same form as the communication connection 20.

In operation, the customer 22 registers with the loyalty tracking system 18 by employing various methods. Once such method is for the customer 22 to use a computer connected to the Internet and to register at a web site associated with or run by the loyalty tracking system 18. A customer 22 may also mail in a registration card, electronically mail a registration, sign up at a remote location, or be given a promotional card. Once registered, the loyalty tracking system 18 may use various identification means to identify the customer 22 for accumulating loyalty points. For example, the customer 22 may use a credit card for purchases from the vending machine 12 and purchases made with a particular credit card would be credited to the account of the customer 22. Other identification means may include a smart card, a cellular phone number, a cell phone, a reusable bill validator identification coupon, an RFID, a PDA device, a generic loyalty card, or a specially issued card having a magnetic stripe. The customer 22 may provide credit card numbers, phone numbers, and other identification numbers during the registration process. When the customer 22 is registered and identifiable, the customer 22 may use the vending machine 12 in the usual manner. For example, the customer 22 may insert coins or bills into the vending machine 12 and also insert the identification card into the input device 14. There may be various displays or screens associated with the vending machine 12 to alert the customer 22 that the coins or bills have been accepted and the identification card has also been accepted. Once acceptance is completed, the customer 22 may select an item from the vending machine 12 and a vend transaction should be completed.

Once a vend transaction has occurred, loyalty points are stored in the automatic merchandiser 12. The loyalty points may be transferred to the loyalty tracking system 18 by use of various methods. For example, the vending machine 12 may be on-line and immediately following a vend transaction the resultant loyalty points may be sent over the connection 20 to the loyalty tracking system 18. In this manner the loyalty points are sent in real time and the customer 22 may be able to use the points immediately. Another method is to store or accumulate the loyalty points in the vending machine 12 and then at a later time, for example once a day, send a batch file of the loyalty points to the loyalty tracking system 18. A further method is to store the loyalty points in the vending machine 12 and then transfer the points via a hand held data collector device used by service personnel that is then transferred from the data collector device to the loyalty tracking system 18. The customer 22 is capable of reviewing accumulated points at the web site associated with the loyalty tracking system 18. The customer 22 may review the reward program, redeem loyalty points for rewards, obtain coupons, and transfer points by using the web site.

As can be appreciated, the loyalty tracking system 18 is capable of gathering and storing information relating to the transactions of the customer 22. The information for a specific transaction may include a date and time, a customer identification number, and an amount of a transaction. The loyalty tracking system 18 is also capable of gathering and storing information relating to registration and identification of the customer 22. The loyalty tracking system 18 may also include a web site that allows for interaction with the customer 22. Accumulated transactions are converted into loyalty points to be used by the customer 22. The loyalty tracking system 18 allows the customer 22 to request redemption of loyalty points for rewards, coupons, or transfer of points to some other loyalty system or program. It is also possible that loyalty points may be redeemed immediately, once a day, at other intervals, or once a threshold amount of points have been accumulated.

The input device 14 may be a credit card reader, a bill validator, a coin changer, a smart card reader, an infrared port, or a device that recognizes input signals such as a Bluetooth type device or other wireless type devices. Most of these devices are well known in the vending industry. In particular, when a credit card or a smart card is inserted into the input device 14 information regarding the card is communicated to the automatic merchandiser 12 via the communication connection 16. The automatic merchandiser 12 may include a transaction controller (not shown) that will be operated to evaluate the card data. If the card is unacceptable for some reason, such as because the card has expired or because inappropriate check sum figures are computed for the card information, the transaction controller can effect generation of a card reject message on a display (not shown) associated with the vending machine 12. Similarly, if the transaction controller determines that the card is acceptable then a vend transaction will be initiated. Further, if the input device 14 is a coin changer or a bill validator then coins or bills may be inserted to initiate a vend transaction. Additionally, the coin changer or bill validator may be programmed to accept a special coin or bill that uniquely identifies the customer 22. In this manner once this coin or bill is identified it may be returned to the customer 22 for other future uses or selections. As indicated above, the input device 14 may include a wireless connection in which radio or infrared signals are received. If the customer 22 has a PDA device that transmits infrared signals, then the input device 14 is able to receive the infrared signal to identify the customer 22 and credit loyalty points to the customer 22 based upon the completed vend transaction and vend amount. Also, it is possible to use a cellular phone to transmit a signal, such as a radio signal to the input device 14. The transmitted signal may include information or data associated with the customer 22 or the identification of the customer 22.

It will be understood by those skilled in the art that the card reader or smart card reader employed, as well as card recognition protocols and techniques for recognizing card validity, are well known and accepted in the art, and all such card readers, protocols, and techniques could be employed in the system and method of the present invention.

Referring now to FIG. 2, a generalized block diagram of the vending machine 12 and the input device 14 are shown. The vending machine 12 operates in accordance with vending machines well known in the art to effect the vending of a selected product after acceptance of coins, bills, or credit and to effect the generation of a vend completion signal upon the completion of a vend operation by the vending machine 12. The vending machine 12 may also include one or more price information data lines over which information regarding the price of the selected product may be communicated from the vending machine 12 to a vending machine controller or a transaction controller 30. If the vending machine 12 is of a single price type, there may be no need for a price data line since all the vends will be at the established price for the single price vending machine. On the other hand if, for example, the vending machine is a 4 price or 10 price model, or a multi-price model, a newer electronic vending machine, or a single price model that has been modified to operate at multiple prices, the data line may be employed to provide price information data from the vending machine 12 to the transaction controller 30.

The transaction controller 30 includes a microprocessor 32 and associated memory 34. The microprocessor 32 operates under program control to effect various operations required of the transaction controller 30. A display 36 is connected to the transaction controller 30 to display various messages to the customer 22. It will be appreciated that the various messages generated by the transaction controller 30 may take various forms and/or be communicated to the user in various manners. For example, an insert card display message may instruct the customer 22 to insert the card to be used to identify the customer 22 for awarding loyalty points for a vend transaction. Such message may be presented by way of an alphanumeric display or even through audio messages, or combinations thereof.

The input device 14 may be connected to the transaction controller 30. A card (not shown) may be inserted into the input device 14 and the transaction controller 30 will be able to read the card and then associate the customer 22 with a vend transaction to award loyalty points. Further, the machine 12 may be programmed to provide a free vend or transaction based upon a lottery type system. In particular, the machine 12 may be programmed to give free product on every hundredth use of a card or at random intervals. Also, the machine 12 may be programmed to provide a discounted price for a product to be vended when the card associated with the customer 22 is inserted into the input device 14. As discussed previously, the input device 14 may include a coin changer device that is capable of being programmed to accept a token or a special coin that associates the customer 22 with a vend transaction. The input device 14 may also be a bill validator device that may be programmed to read a coupon or special bill that is inserted by the customer 22. In this manner, the transaction controller 30 is able to award loyalty points to the customer 22.

A data transfer device 38 is also connected to the transaction controller 30. The data transfer device 38 is used to transfer information related to the customer 22 to the loyalty tracking system 18. As indicted previously, the data transfer device 38 may be connected to the loyalty tracking system 18 by various means that include a telephone line, a cable line, a network connection such as Ethernet, Intranet, or Internet, a satellite connection, an infrared connection, or any other electrical type or dedicated communication type connection such as DSL, ISDN, or T1.

The data transfer device 38 may also include means for transferring information by use of a hand held data transfer device. The use of hand held data transfer devices for the uploading and downloading of information from vending machines, including through DEX connectors, and from microprocessor controlled systems having data transfer connections or infrared or RF communications is well known in the vending industry. Any and all appropriate devices and manners of uploading and downloading information may be employed and utilized. It will be further appreciated and understood that the transaction information downloaded through the data connector to a hand held data transfer device may be subsequently transferred to the loyalty tracking system 18 by various known means and methods. For example, such transaction information may be transmitted immediately to the system 18 or batches or files of transaction information may be transmitted at predetermined time periods. Again, the uploading and downloading of such information is well known in the art and particular manners of transmission are not considered critical to an understanding of the present invention.

It will also be advisable to supply some manner for canceling a transaction in the event of a malfunction of some type with the vending machine 12 or if the customer 22 decides not to purchase an item prior to some point in the vend transaction sequence. This is typically before the vend delivery is initiated. Many manners and techniques for effecting such cancellations are known and employed by vending machines and systems and such methods may be employed with the present invention. Further, once a cancellation is completed, no loyalty points will be awarded and the transaction controller 30 may store and/or transfer this information.

As has been explained hereinabove, the system and method of the present invention can be used with many vending machines that use discrete control and data lines for communication with the transaction controller 30, as well as with vending machines that employ a multi-drop data bus (MDB) arrangement. It has also been noted that the present system and method can be employed with both single and multiple price machines or coin changers and that the price information regarding the selected vend can be provided to the transaction controller 30 either over one or more price information lines or over a bus. It is also possible to use the present system and method in single price machines that employ discrete connections and eight pin Jones plugs, of which there are a large number in use in the field.

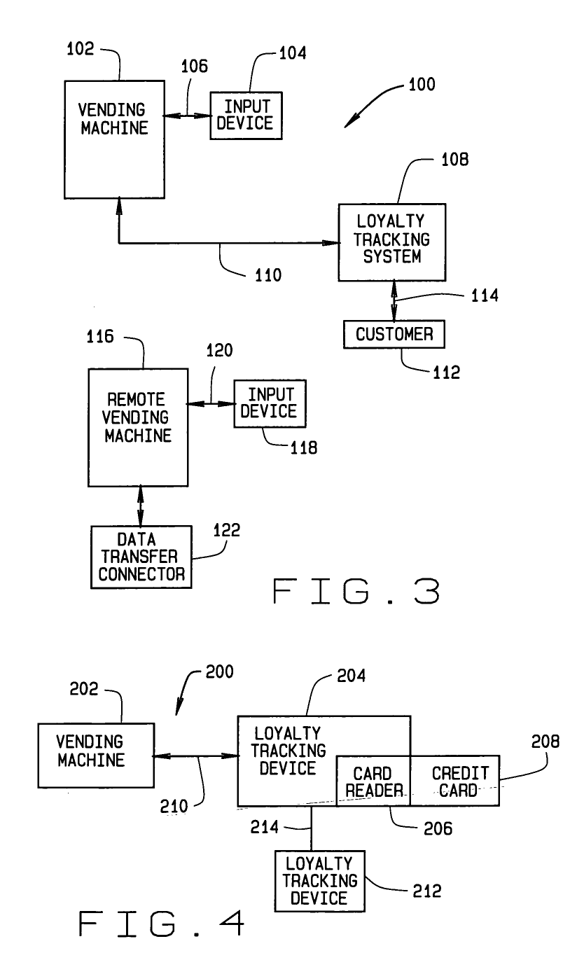

FIG. 3 depicts a block diagram of another preferred embodiment of a loyalty automatic merchandiser system 100. The loyalty automatic merchandiser system 100 comprises a vending machine 102 having an input device 104 with the input device 104 being electrically connected to the vending machine 102 via a connection 106. The vending machine 102 is connected to a loyalty tracking system 108 via a communication connection 110. A customer 112 may interface with the loyalty tracking system 108 through a connection 114. For example, the customer 112 may have a computer connected to the Internet and by use of a browser program may connect to a web site hosted by the loyalty tracking system 108. The connection 114 may be an Internet type connection.

The system 100 also comprises a remote vending machine 116 that has an input device 118 connected to the machine 116 via a link or connection 120. The remote vending machine 116 also has a data transfer connection 112 for transferring information or data from the machine 116 to a hand held data transfer device. As previously indicated, the use of hand held data transfer devices for the uploading and downloading of information from vending machines, including through DEX connectors, and from microprocessor controlled systems having data transfer connections or infrared or RF communications is well known in the vending industry.

The customer 112 registers with the loyalty tracking system 108 by using any method previously described. Once registered, the loyalty tracking system 108 may use various identification means to identify the customer 112 for accumulating loyalty points. The customer 112 may use the vending machine 102 or the remote vending machine 116 to purchase product and to accumulate loyalty points based upon the amount of the purchases. Once a vend transaction has occurred, loyalty points are stored in the vending machine 102 or the vending machine 116. The loyalty points may be transferred to the loyalty tracking system 108 directly over the connection 110 or by use of a hand held data transfer device when the vending machine 116 is used. The customer 112 is capable of reviewing accumulated points at the web site associated with the loyalty tracking system 108. The customer 112 may also review the reward program, redeem loyalty points for rewards, obtain coupons, and transfer points by using the web site.

With reference now to FIG. 4, a block diagram of another preferred embodiment of a loyalty automatic merchandiser system 200 is shown. The system 200 has a vending machine or vending system 202 and a transaction controller or loyalty tracking device 204 associated therewith. The loyalty tracking device 204 includes a card reader 206 that is operable to receive a credit card 208, a smart card, or a card having a magnetic stripe. The loyalty tracking system 204 is connected to the vending machine 202 via a connection 210. The loyalty tracking device 204 is capable of sending data corresponding to identification of a customer or the credit card 208 to a loyalty tracking system 212 via a connection 214. The connection 214 may include, by way of example only, a telephone line, a cable line, a network connection such as Ethernet, Intranet, or Internet, a satellite connection, an infrared connection, a wireless connection, or any other electrical type connection.

In operation, the user of the credit card 208 registers with the loyalty tracking system 212 by using any method previously described. Once registered, the loyalty tracking system 212 may use various identification means to identify the credit card 208 for accumulating loyalty points. The credit card 208 is inserted into the card reader 206 to use the vending machine 202 to purchase product and to accumulate loyalty points based upon the amount or number of the purchases. Once a vend transaction has occurred, loyalty points are stored in the loyalty tracking device 204. The loyalty points may be transferred from the loyalty tracking device 204 to the loyalty tracking system 212 over the connection 214. The user of the credit card 208 is capable of reviewing accumulated points at the web site associated with the loyalty tracking system 212. The user of the credit card 208 may also review the reward program, redeem loyalty points for rewards, obtain coupons, and transfer points by using the web site.

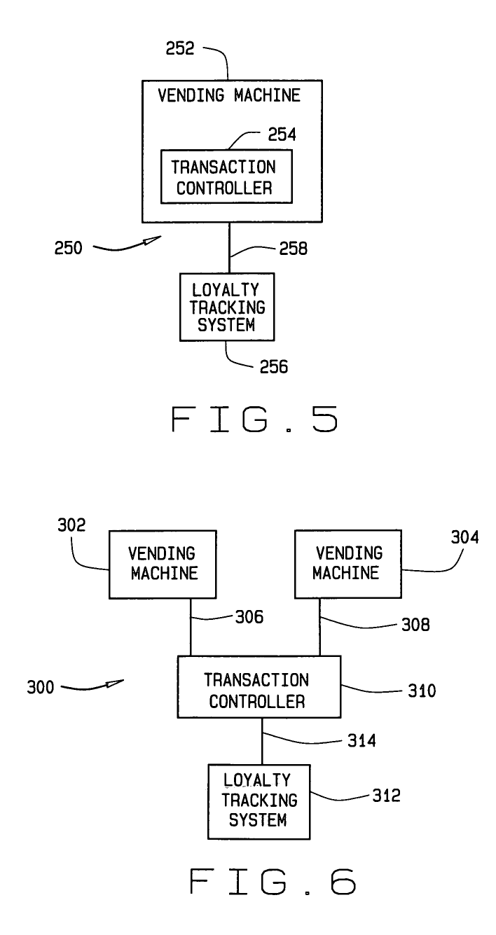

FIG. 5 illustrates another preferred embodiment of a loyalty automatic merchandiser system 250. The system 250 has a vending machine 252 and within the vending machine is a transaction controller 254. The vending machine 252 is connected to a loyalty tracking system 256 by a connection 258. The transaction controller 254 is capable of sending information representative of identification of a user of the system 250 to the loyalty tracking system 256 over the connection 258. The vending machine 252 is capable of receiving an identification card (not shown) such as a credit card, a smart card, or a card having a magnetic stripe. After information from the card is received, the transaction controller 255 will send the information to the loyalty tracking system 256. As previously discussed, the information may be sent by the transaction controller 255 immediately, at predetermined time intervals, or on a daily basis. The received information may be stored in the loyalty tracking system 256 to be reviewed by a user of the system 250.

Referring now to FIG. 6, another preferred embodiment of a loyalty automatic merchandiser system 300 is illustrated. The system 300 has a first vending machine 302 and a second vending machine 304 connected via connections 306 and 308 respectively to a transaction controller 310. The transaction controller 310 is connected to a loyalty tracking system 312 by a connection 314. In this particular embodiment, the transaction controller 310 is a stand alone unit that is not part of the vending machines 302 or 304. Although the two vending machines 302 and 304 are shown, it is to be understood that the system 300 may include only one vending machine or two or more vending machines.

The system 300 operates in the following manner. A customer inserts a card into the vending machine 302 and once a vend transaction is completed a signal is sent over the connection 306 to the transaction controller 310. The signal may include information representative of the amount purchase and an identification code assigned to the particular card used in connection with the vend transaction. The transaction controller 310 is capable of sending this information over the connection 314 to the loyalty tracking system 312. The customer may also then insert the card into the vending machine 304 to accumulate more credits or points based upon the purchase made. This information is also provided to the loyalty tracking system 312 by the transaction controller 310. The transaction controller 310 may be located near the vending machines 302 and 304 and the loyalty tracking system 312 may be at a location remote from the vending machines 302 and 304 and the controller 310.

It will be appreciated by those skilled in the art that certain of the operations and actions as set forth and described herein may be performed in somewhat different orders, without departing from the spirit of the invention, and that the system could be designed to recognize interrupt requests at certain times relative to various control signals or requests instead of having to poll or check certain inputs or data connections.

It will also be understood and appreciated that, while many current card readers or smart card readers include microprocessors programmed to control the operation of the card reader, the transaction controller of the present invention may be so constructed or programmed to be able to control card reader components without the necessity for a separate card reader microprocessor.

From all that has been said, it will be clear that there has thus been shown and described herein a loyalty automatic merchandiser system which fulfills the various objects and advantages sought therefor. It will become apparent to those skilled in the art, however, that many changes, modifications, variations, and other uses and applications of the subject loyalty automatic merchandiser system are possible and contemplated. All changes, modifications, variations, and other uses and applications which do not depart from the spirit and scope of the invention are deemed to be covered by the invention, which is limited only by the claims which follow.

1. A loyalty automatic merchandiser system comprising:
a vending machine capable of vending product, the vending machine having an input device for receiving identification information of a customer purchasing product from the vending machine, and a transaction controller for storing and transmitting information concerning identification information and product purchased; and
a loyalty tracking system for registering a customer and assigning identification information for a customer, for receiving identification information and product purchased from the transaction controller, and for awarding points based on product purchased.

2. The loyalty automatic merchandiser system of claim 1 wherein the input device is a smart card reader.

3. The loyalty automatic merchandiser system of claim 1 wherein the input device is a card reader.

4. The loyalty automatic merchandiser system of claim 1 wherein the input device is a bill validator.

5. The loyalty automatic merchandiser system of claim 1 wherein the input device is a coin changer.

6. The loyalty automatic merchandiser system of claim 1 wherein the vending machine is capable of vending a free product based upon a lottery system upon receiving identification information of a customer purchasing product from the vending machine.

7. The loyalty automatic merchandiser system of claim 1 wherein the vending machine is capable of vending product at a discount based upon receiving identification information of a customer purchasing product from the vending machine.

8. The loyalty automatic merchandiser system of claim 1 further comprising a second vending machine capable of vending product, the second vending machine having an input device for receiving identification information of a customer purchasing product from the second vending machine, a transaction controller for storing and transmitting information concerning identification information and product purchased, and a data transfer connector for transferring stored information concerning identification information and product purchased to a hand held data transfer device.

9. A loyalty automatic merchandiser system comprising:
a vending machine capable of vending product, the vending machine having an input device for receiving identification information of a customer purchasing product from the vending machine;
a transaction controller connected to the vending machine, the transaction controller for storing and transmitting information concerning identification information and product purchased; and
a loyalty tracking system for registering a customer and assigning identification information for a customer, for receiving identification information and product purchased from the transaction controller, and for awarding points based on product purchased.

10. The loyalty automatic merchandiser of claim 9 wherein the identification information is stored on a magnetic stripe card.

11. The loyalty automatic merchandiser of claim 9 wherein the identification information is stored on a smart card.

12. The loyalty automatic merchandiser of claim 9 further comprising a second vending machine capable of vending product, the second vending machine having an input device for receiving identification information of a customer purchasing product from the second vending machine and the second vending machine being connected to the transaction controller.

13. The loyalty automatic merchandiser of claim 9 wherein the input device is a smart card reader.

14. The loyalty automatic merchandiser of claim 9 wherein the input device is a bill validator.

15. The loyalty automatic merchandiser of claim 9 wherein the input device is a coin changer.

16. The loyalty automatic merchandiser of claim 9 wherein a customer may access the loyalty tracking system to determine the number of points awarded.

17. A loyalty automatic merchandiser system comprising:
a vending machine capable of vending product, the vending machine having a transaction controller, the transaction controller having an input device for receiving identification information of a customer purchasing product from the vending machine with the transaction controller for storing and transmitting information concerning identification information and product purchased; and
a loyalty tracking system for registering a customer and assigning identification information for a customer, for receiving identification information and product purchased from the transaction controller, and for awarding points based on product purchased.

18. The loyalty automatic merchandiser system of claim 17 wherein the vending machine is capable of vending a free product based upon a lottery system upon receiving identification information of a customer purchasing product from the vending machine.

19. The loyalty automatic merchandiser system of claim 17 wherein the vending machine is capable of vending product at a discount based upon receiving identification information of a customer purchasing product from the vending machine.

20. The loyalty automatic merchandiser system of claim 17 wherein a customer may access the loyalty tracking system to determine the number of points awarded.
